(19) United States
(12) Patent Application Publication
(10) Pub. No.: US 2017/0237289 A1
(43) Pub. Date: Aug. 17, 2017

(54) METHOD AND APPARATUS FOR REMOTE ELECTRICAL LOAD MANAGEMENT

(71) Applicant: Murata Manufacturing Co., Ltd., Kyoto (JP)

(72) Inventors: Tobe J. Thompson, Dallas, TX (US); Joseph W. Pollard, Plano, TX (US); David E. Booty, Jr., Dallas, TX (US)

(21) Appl. No.: 15/504,305

(22) PCT Filed: Jan. 22, 2015
(86) PCT No.: PCT/US2015/012359

§ 371 Date: Feb. 15, 2017

Related U.S. Application Data
(60) Provisional application No. 62/039,699, filed on Aug. 20, 2014.

(51) Int. Cl. H02J 13/00; G05B 15/02; H02J 3/14

(52) U.S. Cl. CPC H02J 13/0062; H02J 3/14; G05B 15/02; H02J 2003/003

(57) ABSTRACT

A computerized method allowing automated building energy management is provided, including specifically automated electric load shed in response to load shed programs and the like. The method also provides for automated electric load increases in response to certain conditions. The system allows for remote and automated managing, coordinating, and implementing of electrical load changes or modifications at a facility having electric equipment.

### FIELD OF INVENTION

The present invention is in the technical field of electrical resource management, and more particularly to apparatus and methods for managing, coordinating, and implementing electrical load curtailment or modification at a facility.

### BACKGROUND

Energy consumption continues to increase and energy supply is limited and often unable to meet consumer demand. Particular shortage problems occur during peak demand, emergency conditions, grid instabilities, or in response to weather variations. Energy conservation and usage reduction have become important aspects of balancing energy needs and supply. Responses to short-term energy shortages include the development of load shed programs, load demand programs, energy spot-markets, peak load response, and intermittent self-serve and excess energy generation. These programs help balance the grid, allow grid operators to deliver reliable supply, and reduce energy cost spikes.

### BRIEF DESCRIPTION OF THE DRAWING

The present disclosures are described by reference to drawings showing one or more examples of how the disclosures can be made and used. In these drawing, reference characters are used throughout the several views to indicate like or corresponding parts. In the description which follows, like or corresponding parts are marked throughout the specification and drawing with the same reference numerals, respectively. The drawing does not purport to be to scale and proportions of certain parts have been exaggerated to better illustrate details and features.

FIG. 1 is a schematic of an exemplary computerized architecture with hardware and software according to an aspect of the invention;

FIG. 2 is a schematic of an exemplary architecture for providing distributed services according to an embodiment of the disclosure;

FIG. 3 is a diagram of an exemplary load curtailment service provided according to an aspect of the disclosure;

FIG. 4 is a schematic of an exemplary DR tree structure according to an aspect of the disclosure;

FIG. 5 is a schematic of an exemplary notification service according to an aspect of the disclosure;

FIG. 6 is a schematic of an exemplary real-time messaging service according to an aspect of the disclosure;

FIG. 7 is a schematic of an exemplary scheduling service according to an aspect of the disclosure;

FIG. 8 is a schematic of an exemplary rules service according to an aspect of the disclosure;

FIG. 9 is a schematic of an exemplary metering service according to an aspect of the disclosure;

FIG. 10 is a schematic of an exemplary simple gateway service according to an aspect of the disclosure; and

FIG. 11 is a schematic of an exemplary Controller messaging service according to an aspect of the disclosure.

### DETAILED DESCRIPTION

For a more complete understanding of the features and advantages of the present invention, reference is now made to the detailed description of the invention along with the accompanying figures in which corresponding numerals in the different figures refer to corresponding parts.

For purposes of this disclosure, several terms are particularly defined. When those terms and equivalents are used in the claims, the terms shall have the meaning set forth as defined herein. Where terms are not particularly defined, they are used in their normal sense in the industry.

Definitions

An electrical grid or simply “the grid” is an interconnected network for delivering electrical power from suppliers to consumers. It consists of electrical suppliers acting as power generating stations that produce electrical power, an electrical transmission network having power lines to carry electrical power from electrical suppliers to intermediate demand centers, and a distribution network that delivers electrical power to individual consumers.

Electrical Suppliers may be located near a renewable or non-renewable fuel source and are typically large enough to provide economies of scale. Generally, the transmission network moves power to reach one or more substations, typically via high-voltage power lines. A substation can encompass, for example, wholesale consumers, demand centers, local distribution networks, etc. The substation may be wholly or partly owned by one or more power suppliers, local distributors, etc. Power flows into the distribution network comprising a multitude of distribution lines to consumers, typically retail consumers. The generated and distributed electrical voltage is typically stepped up and down at various points between suppliers, the transmission network, substations, the distribution network, and/or consumers.

A grid operator is any regional transmission organization (RTO) or independent system operator (ISO) responsible for monitoring, coordinating, and controlling electricity transmission across an electrical grid. Grid operation varies across regions and states and can be the responsibility of a governmental or regulatory entity, a private entity with or without governmental oversight, or a combination thereof. A grid operator can further contract with third-parties to provide various services, such as software and hardware vendors, service providers, data management services, etc. Such third-parties under the control of the grid operator are considered indistinguishable from the grid operator herein.

A consumer, customer, or user is an entity requiring electrical power and consuming an electrical load to operate their electrical equipment (e.g., lights, appliances, industrial equipment, HVAC, etc.). A consumer can be a single entity, such as a business, a building, an industrial or commercial facility, private or public facility, single or multiple-family dwelling, etc., or can be an agglomeration or subdivision of the same. Typical consumers participating in load curtailment programs or similar tend to be large facilities, agglomerations of commercial buildings, campuses, etc.

Electrical Load refers to the amount of power being used at a selected moment (e.g., by a device, Facility, all consumers on the grid, etc.), the (maximum) power usage capacity (of the device, Facility, etc.), or the sum of power demands on a network (e.g., the grid) and is typically measured in kilowatts (kW) or megawatts (MW).The electric load can vary based on conditions, such as whether the device is running at full or partial power, variance in the load (mechanical, heat, light) borne by the equipment, device efficiency and condition, ambient conditions, etc. In a Facility, the current load will vary depending on the equipment in use, whether the equipment is running at full power, etc.

Electrical Load Consumption generally refers to the amount of power used over a period of time, and is typically measured in kilowatt-hours (kWh) or megawatt-hours (MWH).

As used herein, Facility is used generically to refer to an entity pulling an electrical load. Facility Load refers to the electric load of the entire Facility, including all of the electrical devices drawing power in the Facility.

Electrical Equipment as used herein refers to any machine, appliance, or system which uses electricity to operate. Electrical equipment has an associated electrical equipment load pulled during operation. Electrical equipment includes lighting, HVAC, fans, computer systems and networks, security systems, monitoring equipment, machinery, appliances, etc. Generally, Electrical Equipment also includes devices producing electrical energy (e.g., generators). Generator is used herein to generically indicate a power-producing device at a Facility for meeting part or all of the Facility's power needs or for generating excess power for sale into the grid or on the energy market. Many types of power generator exist, including solar, wind, hydrocarbon-fueled generators, etc.

Electrical equipment can be categorized. For example, electrical equipment can be categorized according to load nature (resistive, capacitive, inductive, linear or non-linear), function (lighting, receptacles, small and large appliances, HVAC systems, power loads, etc.), consumer type (residential, commercial, industrial), load grouping, load operation time (continuous, non-continuous, intermittent, periodic, varying, etc.), criticality levels (vital, life safety, essential, emergency, non-essential, etc.), actual load value (nameplate load, full load, percent of full load, no load, etc.), operational coincidence, method of load reduction or control (dimmed, shed, shifted, etc.). Categorization can be useful as part of creation of pre-planned Load Curtailment Schemes, including alternative schemes, back-up schemes, secondary schemes, and variable schemes for a Facility.

Controllers are include building automation systems and computers for controlling (e.g., on/off, power up, power down, etc.) multiple electrical devices at a Facility. Controllers are commercially available, for example, from Tridium, Inc. and Honeywell, Inc., and under various trade names, such as Tridium's JACE (trade name) (Java Application Control Engine) series controllers, and Honeywell, Inc.'s WEBs-AX (trade name) controllers. Controllers can also provide monitoring, communications, data storage, and logic services. A controller provides connectivity to diverse systems within a Facility. To integrate diverse systems, a connection to a device's network is required. By connecting common network protocols such as LonWorks, BACnet, Modbus, etc., proprietary networks, and combinations thereof, a unified system is provided. Scalability and reliability are possible using the distributed architecture that a network of Controllers creates. Controllers can use proprietary or open protocols, have multiple ports, wired and/or wireless, for connectivity to equipment. For example, a Controller can have available LonWorks ports, RS-485 ports, RS-232 ports, and input/output modules. Remote and stand-alone controllers are available and can support multiple field busses. Controllers can communicate with other devices via Ethernet-based and other protocols such as OPC, BACnet IP, Modbus TCP, and SNMP.

Load Shed Program as used herein refers to any of a variety of programs available (or which may be made available) in which a consumer voluntarily or obligatorily agrees to curtail, reduce, shed, eliminate or otherwise change their electrical load on the grid in response to a demand, request, or signal (generally, Load Shed Signal). The Load Shed Signal can issue from a grid operator (or the like) (in response to an emergency, grid instability, or economic incentive program) or based on market conditions (e.g., pricing). Load Shed Programs, as used herein, is intended to be a broad term and is not limited to curtailment programs.

Load Shed Programs includes private and public programs for load curtailment or elimination, local generation (distributed generation) for local use or market sale, and electricity sale to the market (whether a grid operator, supplier, distributor, or the open spot-market). Some programs reward energy storage to arbitrage between low and high demand or price periods.

A Load Shed Signal can originate from a grid operator or the like, from a private-sector program or service in response to market conditions (e.g., current or expected market prices on the spot-market), or other source.

Load Shed Programs are typically incentive-laden, for agreement to participate, actual load shedding in response to a demand signal, providing power into the grid, etc. Incentives can be payments, energy credits, monetary credits, rate reductions or discounts, or other valuable consideration. Incentives issue from the grid operator, load service provider, government entity, power or utility company, etc. The program may be regulated or controlled by one entity (e.g., a grid operator) while incentives are supplied by a different entity (e.g., utility company). A Load Shed program, as used herein, includes consumer-operated or consumer-implemented plans (and third-party operated) to minimize the consumer's peak load by curtailing their electrical load at times of peak grid demand or expected peak grid demand, to sell consumer-generated power into the grid, or to sell contracted power into the market. Negative incentives, such as exclusion from the program, fines, fees, etc., can apply as well.

Load Shed Programs are available under a number of names, such as load curtailment programs, emergency response service, load resource or generator participation, voluntary load response, demand response programs, market load response, peak response, price response, rate response, ancillary services, load shed programs, etc.

Load Shed Programs typically involve an agreement between a power consumer and a power provider, grid operator, etc. The consumer, typically single or aggregated commercial or industrial facilities (and increasingly residential), agrees to curtail their energy load by a predetermined amount upon receipt of a Load Shed signal. Under some programs, the consumer agrees to meet a portion or all of its power needs using generators under its control or provide excess power back into the grid.

Once the period of time indicated for the load shed demand has passed, the consumer is free to transfer its load back to the grid, increase or resume its electrical load, or cease supplying excess capacity to the grid. Generally, one or more of these or other actions taken when a Load Shed event has passed, are referred to herein as Load Restoration or similar.

Load Change, Load Change Program, Load Change Signal, Load Change Event, and the like, as used herein refers to not only Load Shed programs, signals, etc., as discussed above, but also to such programs, signals, etc., directing, automating, or indicating an increase in electrical load. These terms are used as a convenience to refer to many disclosed features and methods herein which are equally applicable for automated load shed (decrease) and automated load increase events. Similarly, where the description of embodiments refer to “load shed,” “load curtailment,” and the like, it is also likely that the same features are applicable or can be modified to apply to load increases.

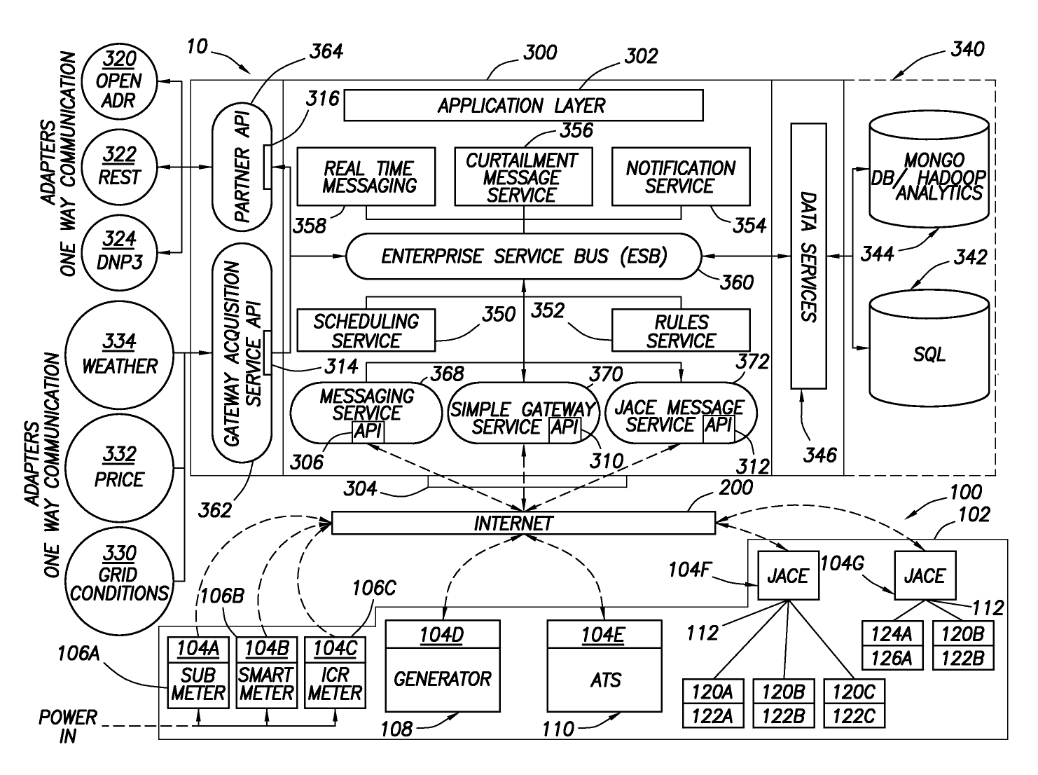

FIG. 1

FIG. 1 is a schematic of an exemplary computerized architecture or system with hardware and software according to an aspect of the invention and generally designated 10.

A remote, private, electrical power control network 100 is located at or associated with a Facility 102. The network 100 is referred to as private to distinguish it from “public” networks (e.g., the internet). The private network can have multiple authorized users, buildings, systems, etc., but is administered as a single Facility for purposes of electrical use management. To indicate that the Facility's electrical device installation and maintenance is typically independent of the load curtailment service provider network, the network 100 is referred to as “remote.” A Facility can have multiple networks for various functions and controls, however, the relevant network or networks here are those connected to and functioning to control the Facility's electrical equipment, equipment monitoring, and metering.

The remote network 100 can include multiple gateways 104. Gateways 104 are associated with a plurality of meters 106, such as sub-meters 106a, smart meters 106b, and Internal Data Recorder (IDR) meters 106c. Gateways are also associated with other control, data, and/or metering devices, such as a generator gateway 104d for generator 108, an automatic transfer switch (ATS) gateway 104e for ATS 110, and gateways 104f-g for Controllers 112.

A gateway can be implemented on a physical device (gateway-router-switch) operably connected to one or more electrical devices or can be a software application layer running at some level of the network and operably connected to the devices. For devices lacking a built in gateway, such as sub-meter 106a, a gateway 104a can be connected to communicate with the device and a network. The gateway can be hardware and/or software located at the sub-meter, on a device (e.g., server, computer) connected to the sub-meter, etc. The gateway associated with sub-meter 106a can communicate with the sub-meter, communicate with the internet, and/or solicit, store, and/or transmit sub-meter data 114a to the internet 200. Communication between gateways and equipment, between pieces of equipment, between gateways, between gateways, equipment and the internet, etc., can be via various known standards and specifications, such as Ethernet, ZigBee, 900-network signal hopping, etc., as is known in the art and as may be later developed.

Gateways, alternately, can be “built-in,” coded into, or an integral part of a larger device or application. For example, smart meters 106b and IDR meters 106c have gateways 104d and 104e built in to the meter device for storing meter data and communicating data to and from the internet. Generators, such as generator 108, typically include various sensors (e.g., temperature, oil pressure) for monitoring the status of the generator, and a gateway 104d for managing and communicating resulting data. Similarly, an ATS 110 typically includes an associated gateway 104e. Controllers 112a-b also include or serve as gateways 104f-g, providing connectivity integrally with other services of the device. For example, a JACE (trade name) controller includes software and hardware necessary to connect to and communicate over the internet.

The various gateways 104 communicate and interconnect with the internet (cellular, or other network) by wire or wireles sly, as is known in the art. Further, FIG. 1 illustrates each of the several gateways 104 communicating directly with the internet. In various embodiments, one or more on-site gateways can communicate to additional on-site gateways, thus limiting the number of gateways communicating directly over the internet. That is, it is possible to bundle data from multiple on-site gateways using a single gateway to communicate over the internet.

The Service Provider Network, generally indicated as 300, provides remote, electrical load management services, implemented by computer software resident on computer hardware, with respect to Load Shed Programs and Signals for one or more Facilities. The service network includes what is generally referred to as a software Application Layer 302 for specifying provider network protocols, coordinating communication between provider applications and equipment, and providing a graphic user interface (GUI).

The Service Provider Network is in communication via the internet (and/or cellular network) with Facility gateways 104 using one or more provider gateways 304. Again, such gateways 304 can be software, hardware, or a combination thereof, and can be located on various equipment and at various network levels. The provider gateways provide internet connectivity and operable interfacing with Facility gateways.

The Service Provider Network further employs one or more APIs (application programming interfaces) for use in receiving and translating data from various non-provider networks, equipment, or applications, accessing software or hardware, allowing third-party applications to be built for use with the Service Provider Network and applications. For example, Service Provider Network APIs can include one or more metering service API 306, simple gateway service API 310, Controller message service API 312 (e.g., JACE (trade name) or HONEYWELL (trade name) API), data acquisition service API 314, partner API 316, and other current or future APIs. The simple gateway service API allows data communication between the Service Provider Network and those Facility gateways, such as generator gateway 104d and ATS gateway 104e, using the simple gateway service API. The metering service API similarly allows communication with the gateways 104a-c associated with the Facility meters 106a-c.

The partner API 316 allows communication with a partner entity or its network, software, etc. Partners or partner entities can be a data analytics service, a grid operator, an electric load data aggregator (e.g., EnerNOC, Inc.), a Load Shed Program administrator, etc. The partner API can use various standard and proprietary communication architectures, such as partners employing Open ADR (Open Automated Demand Response) 320, partners employing REST (Representational State Transfer) 322, partners using DNP3 (distributed network protocol) 324, XML (Extensible Markup Language), etc. The partner APIs allow two-way communication between the Service Provider Network and its partners' networks or applications.

Similarly, the data acquisition API 314 enables one-way communication of data, such as data scraping, stripping, or mining, from public or private websites or networks to populate data at the Service Provider Network. For example, the data acquisition API permits communication of grid conditions 330 (e.g., current grid load, forecast peak loads, historical peak loads, etc.), market conditions 332 (e.g., historical and current data, ask and bid prices, spot-market data, etc.), and weather data 334 (e.g., current and forecast temperatures, humidity, precipitation, etc.). Other data types can be acquired as well.

The Service Provider Network can further include desktop and laptop computers, smart mobile devices, servers (virtual or real), databases, ESB (enterprise bus servers), routers, back-up power, wiring, wireless equipment, redundant systems, etc., such as are known in the art and are apparent to those of skill in the art. The Service Provider Network components need not be located at the same physical location but are operably connected (e.g., via the internet, network, etc.). The software for performing the services can be resident on one or more local computers (e.g., servers, etc.) or one or more remote computers (e.g., servers, hosted servers, etc.). For example, data storage and processing services can occur remotely to the service provider, in the cloud, on the internet, at a dedicated host server, under the control or management of a third-party contracted for that purpose.

Data storage and processing services 340 are also provided. Databases 342 and 344 can be servers, virtual servers, relational database management systems, hardware clusters, hard drives, etc. Data services 346 can include one or more applications for data processing, querying, and manipulation. For example, a Structured Query Language (SQL) or the commercially available APACHE (trade name) HADOOP (trade name) can be used. Data storage and data services can be located or performed on-site or remotely via the internet and allow the Service Provider or other user to access, manage, upload and download data, and query the databases and data services as needed. Other data storage, management, processing, and analytics products and types will be apparent to those of skill in the art.

The data services allow a Service Provider or customer to input queries, receive corresponding data, and in some embodiments run algorithms. For example, a query can request, for a given customer or Facility, a sum of multiple meter readings every 15 minutes for the last month. The data services communicate a query to database software, whether local or remote, translate the query protocols if necessary to allow an effective interface, receive the resulting queried data, and present it to the inquirer. The retrieved data can be stored for later use by the inquirer. Other query examples include requesting data for Peak Usage statistics, meter readings corresponding to a selected outdoor temperature range, comparisons of profits or savings for various curtailment or energy production strategies, efficiency algorithms, etc. For example, a query and associated data services can determine a selection of power curtailment measures on non-critical equipment necessary to maintain peak efficiency usage for a selected piece of equipment (e.g., HVAC). For customers with multiple Facilities, the data services can provide cumulative and comparative data across some or all selected Facilities.

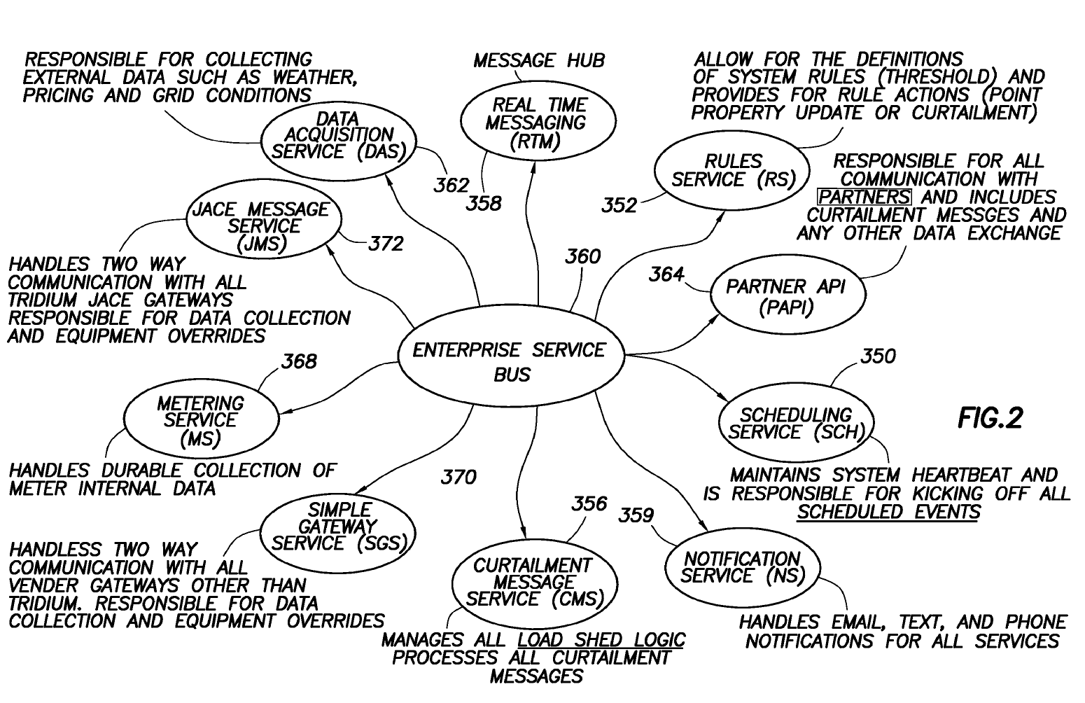

FIGS. 2-11

The Service Provider Network 300, in various embodiments, provides a plurality of software-executed services undertaken by or under the control of the Service Provider on behalf of the Facility 100. The services include one or more of the following: scheduling service 350, rules service 352, notification service 354, curtailment message service 356, real-time messaging service 358, data storage, management and analytics service 340 (“data service”), data acquisition service 362, partner communication service 366, metering service 368, simple gateway service 370, and Controller message service 372. Other services can be provided as well. Real-time, near real-time, and the like, as used herein, means of or relating to a system in which data is processed and/or communicated within fractions of a second so that it is available virtually immediately, or of or relating to a data processing system in which a computer receives constantly changing data (such as data related to current facility load) and processes the data sufficiently rapidly to be able to control the corresponding or implicated equipment (such as electrical equipment, gateways, etc.).

In the embodiment seen in FIG. 1, the services communicate with and through an ESB 360. This provides advantages in scalability as it distributes service performance across multiple servers or other computer devices. Alternately, services can be performed on other platforms using cloud computing, for example. Commercially available services providing a platform, infrastructure, and software are available using cloud computing. For example, cloud solutions are available from AMAZON (trade name) Web Services such as Elastic Compute Cloud (EC2), from MICROSOFT (trade name) AZURE (trade name), and GOOGLE (trade name) Compute Engine. Unless otherwise claimed, the particular location and type of infrastructure, hardware, software, hierarchy, etc., is not critical. Persons of skill in the art will recognize additional distributed and local systems capable of performing the services and functions described herein.

The services can be provided using applications resident on a customer device (e.g., desktop computer, server, etc.), resident on a provider device, or resident on a remote device (e.g., in the cloud, etc.). The services can be provided as Software as a Service, as explained elsewhere herein, and/or related services such as Infrastructure as a Service, Platform as a Service, unified communications as a service, etc.

The Service Provider Network monitors Facility gateway activity, pushes and pulls data to and from the gateways and, through the gateways, monitors Facility electrical equipment and meters, such as meters 106, generator 108, ATS 110, Controllers 112, and other equipment, when present. Monitored conditions include: current total and/or partial Facility loads, current equipment loads, meter readings, current equipment parameters (e.g., on/off, percentage of equipment maximum load, fan speeds, revolutions per minute (rpm), duct back-pressure, pump speed, oil pressure, water or coolant temperature, mechanical load, etc.), etc. The Service Provider collects and stores such data and can further manage, analyze, and manipulate collected data.

FIG. 2 is a schematic of an exemplary computerized architecture or system for providing distributed services according to an embodiment of the disclosure. An ESB 360 is operably connected to software and hardware hosting various provider services, namely, scheduling service 350, rules service 352, notification service 354, curtailment message service 356, real-time messaging service 358, data storage, management and analytics service 340 (“data service”), data acquisition service 362, partner communication service 364, metering service 368, simple gateway service 370, and Controller message service 372. One or more, and other types of, bus can be used. Further, in some embodiments a bus is not used.

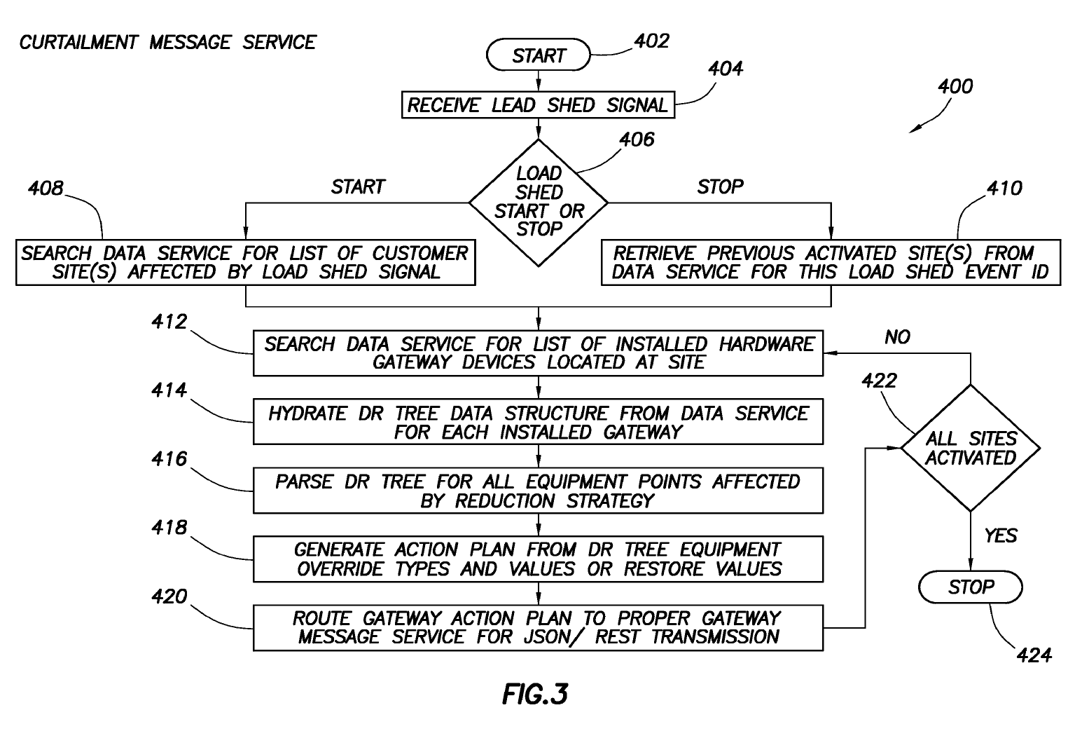

FIG. 3 is a diagram of an exemplary load curtailment service provided according to an aspect of the disclosure. A curtailment message service is provided, generally designated 400. The service starts at 402, by receiving a Load Shed Signal 404, which triggers the curtailment service. Based on the Load Shed Signal, the service continues by initiating a “start” or “stop” curtailment message service 406. The Load Shed Signal, as explained elsewhere, can originate from, or be activated by, various sources (grid operator, service provider, market monitoring software, etc.) and for various purposes (Load Shed Program compliance, market-driven action, etc.), including by or from source websites, automated or manual communication services, etc.

If the signal indicates to start a curtailment message, the software-implemented service searches a database for and identifies one or more Facilities affected by the Load Shed signal 408. If the signal indicates to stop a curtailment in response to a previous Load Shed signal, the software-implemented service continues by searching a database for and identifying one or more previously affected Facilities 410.

Once an affected Facility is identified, at 412 the software-implemented service continues by searching a database for a list of installed gateways at the affected Facility 412, hydrating a DR tree data structure received from the data service for each of the Facility gateways 414, and parsing the DR tree for affected electrical equipment 416 in accordance with a pre-planned and selected Load Curtailment Scheme. The selected Load Curtailment Scheme can be selected from numerous such stored schemes based on an applied logic, such as selecting a scheme based on conditional criteria and rules (e.g., date, time, current Facility and equipment loads, targeted load reductions, correlation of Load Shed signal type to scheme, etc. At 418 the service generates Facility gateway instructions for each of the affected Facility gateways. At 420, the service routes and sends, via the internet, gateway instructions to the affected Facility gateways. For simple gateways, instructions are sent point-by-point for the connected equipment. For “smart” gateways and gateways having local data storage, such as with Controllers, a set of point-by-point instructions can be sent, or a “go” command can be sent with the Controller then implementing point-by-point instructions to implicated equipment.

The service 400 insures activation of the gateway instructions by communicating with the affected Facility gateways at 422. The service “confirms receipt” and/or “confirms activation” by communication with the Facility gateways. If the instructions were not received or implemented completely, a “No” answer starts the process again at 412. A “Yes” answer stops 424 the curtailment service. Further, the confirmation or verification data can supply data such as to whether the failure was an equipment or point failure, a Controller failure, etc.

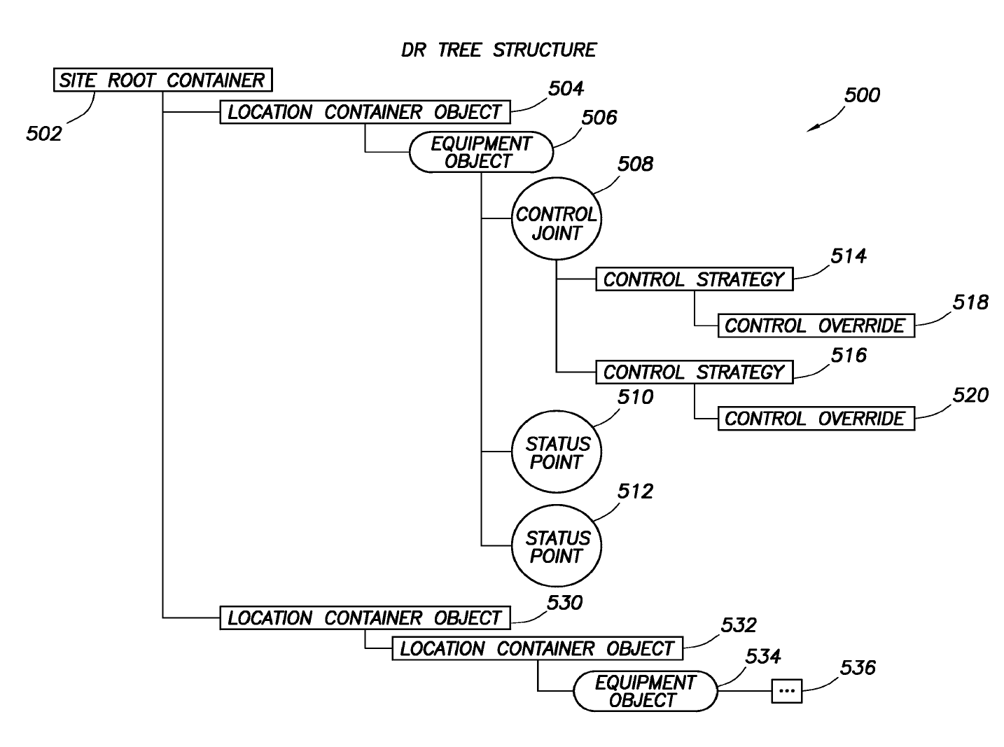

FIG. 4 is a schematic of an exemplary Tree Structure 500 according to an aspect of the disclosure. The tree structure shown is a DR tree structure but other tree structures can be used as is known in the art, such as balanced, unbalanced, bead, etc. Block 502 is a site root container, block 504 a location container object, and block 506 an equipment object. From the block 506 extend multiple blocks, namely, control point 508, status point 510, and status point 512. From the control point block 508 extend control strategy blocks 514 and 516, each having a block 518 and 520, respectively, for control override. The control override can be Boolean, numeric, enumerated, numeric ramp, numeric adjust, cycling, etc.

Block 530 is a location container object, with a depending block 532 location container object. As at 504 and 506, the location container object 532 branches to equipment object 534. Further branching is indicated as continuing indefinitely at block 536 to indicate extension of the tree to all affected location container objects, equipment objects, control points, etc.

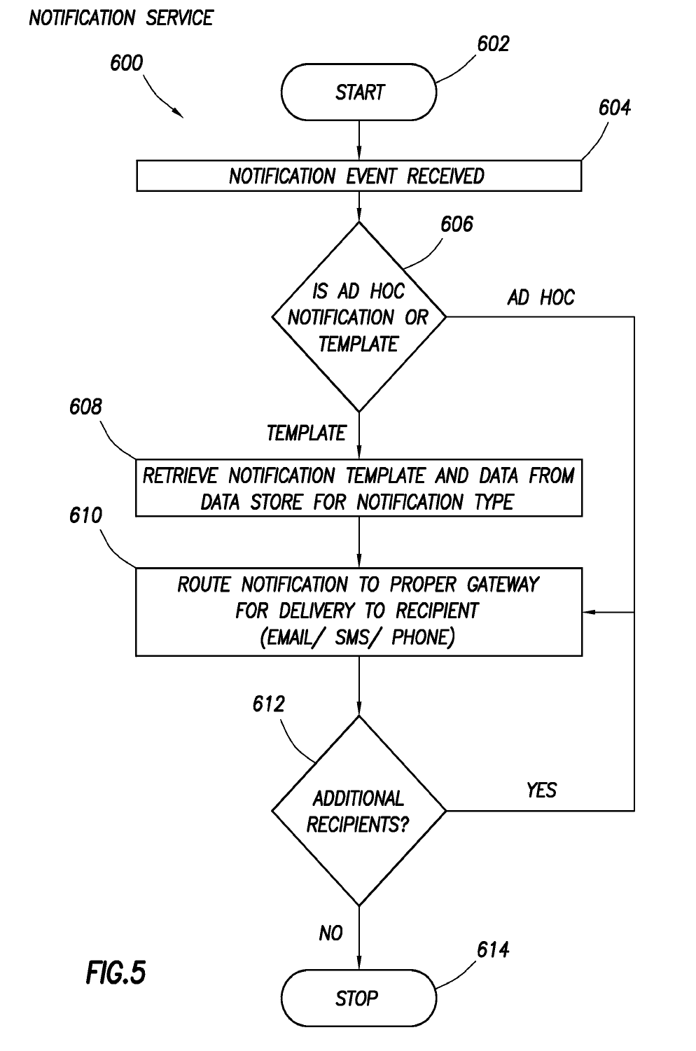

FIG. 5 is a schematic of an exemplary notification service 600 according to an aspect of the disclosure. The service starts at 602. Receipt of notification of an event is indicated at 604. A query 606 indicates identification of the received notification as an “ad hoc” notification or a “template” notification. Various types of notification can be identified and handled accordingly, with the ad hoc and template notifications indicating potential types. If the received notification is identified as a template, then at 608 the service retrieves the notification template and data from a database for notification types. At 610 the service routes a notification message to a proper service provider gateway for delivery to a corresponding recipient. Similarly, if the notification was identified as ad hoc, the service jumps to block 610 and routes the message. The gateway can send the notification message via one or more system, such as text, email, telephone, etc. The notification message can be sent to multiple persons and via multiple gateways as desired, with a query for additional recipients at 612 leading to additional message routing if “Yes” and to a stop 614 if “No.” Generally, the notification service correlates contacts (e.g., persons, administrators, mobile devices, etc.) to a Load Shed event and sends corresponding messages to indicate the event occurrence or Facility curtailment.

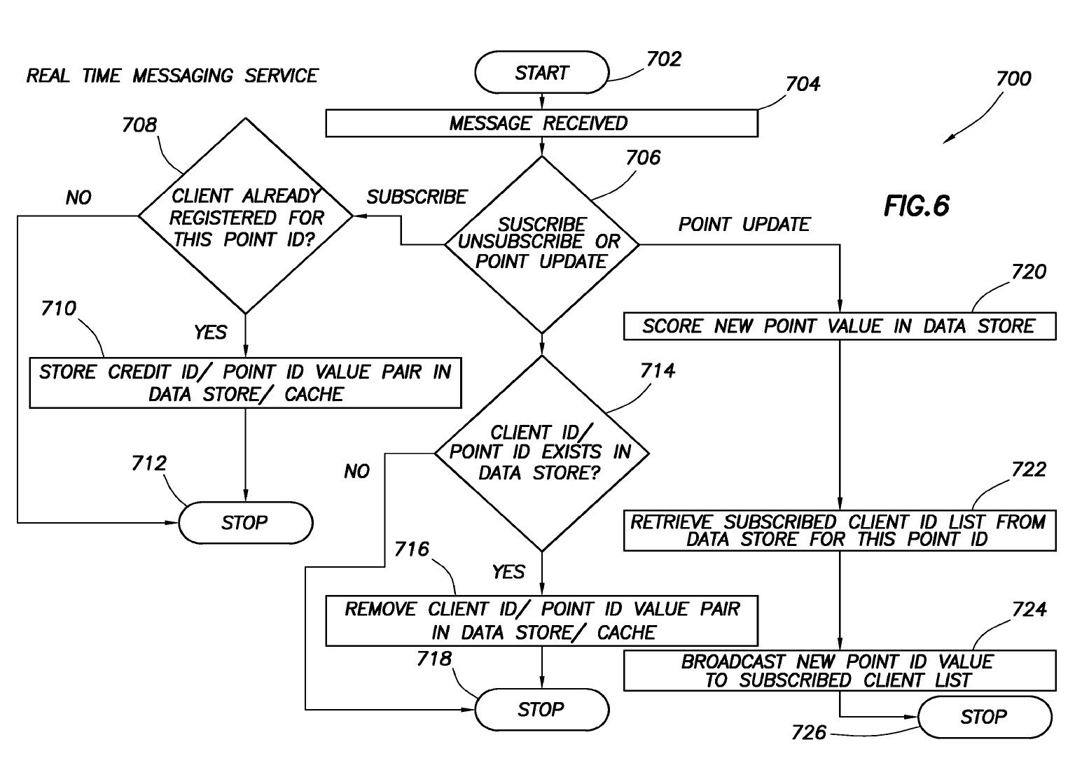

FIG. 6 is a schematic of an exemplary real-time messaging service 700 according to an aspect of the disclosure. The real-time messaging service can be thought of as a real-time, automatic, notification or messaging hub. The service starts at block 702 and a message is received 704. A determination is made as to whether the message is to subscribe, unsubscribe, or provide a point update at 706. Where the message is to subscribe, a determination is made as to whether the client is already registered for the point identification at 708. If so, the process stops at 712. If not, the client identification and point identification value pair are stored, typically in a data store and cache. If the message is to unsubscribe, a query determines whether the client identification and point identification exists in the data store. If no, the process stops at 718. If so, the identification pair is removed from the data store. If the message is a point update, the new point value is stored at 720, a subscribed client identification list is retrieved for the point identification at 722, and the new point identification value is broadcast to the subscribed client list at 724. The process stops at 726.

The real-time messaging hub or service provides real-time data and information to a consumer, whether at a facility, off-site, etc., via the internet. The real-time data is displayed on a consumer display such as a computer or touch screen, as is known in the art. The display layout can be referred to as a “dashboard” providing real-time data, historical data, etc., to the consumer (or other user). The real-time messaging hub provides the information to the consumer's computer or display device automatically updating the data. It is not necessary for the consumer to refresh or otherwise take action to update or download newly acquired data. The real-time updates are sent from the provider server in one embodiment. The user can “subscribe” to receive identified data and so personalize their dashboard to display the data in which they are most interested. For example, the user can subscribe to the server to receive automated updates of data such as: meter readings, equipment loads, facility load, grid conditions, market conditions, weather conditions, connectivity verifications, historical data, expected or predicted data (i.e., comparing current facility load with a previous facility load, comparing a current facility load with anticipated facility load, etc.). Subscriptions can also be made to display periodic data or to data upon certain conditions (i.e., grid data only if grid use is within 20 percent of capacity, weather conditions only if predicted temperatures reach a set degree, etc.). The dashboard, subscription services, etc., can require the downloading, installation and use of a software application on the user's device. Obviously, such a real-time messaging service requires an internet connection between the user's device(s) and the service provider's server(s) or other electronic equipment. Subscription events can be handled directly on the provider server, the user having access to the server.

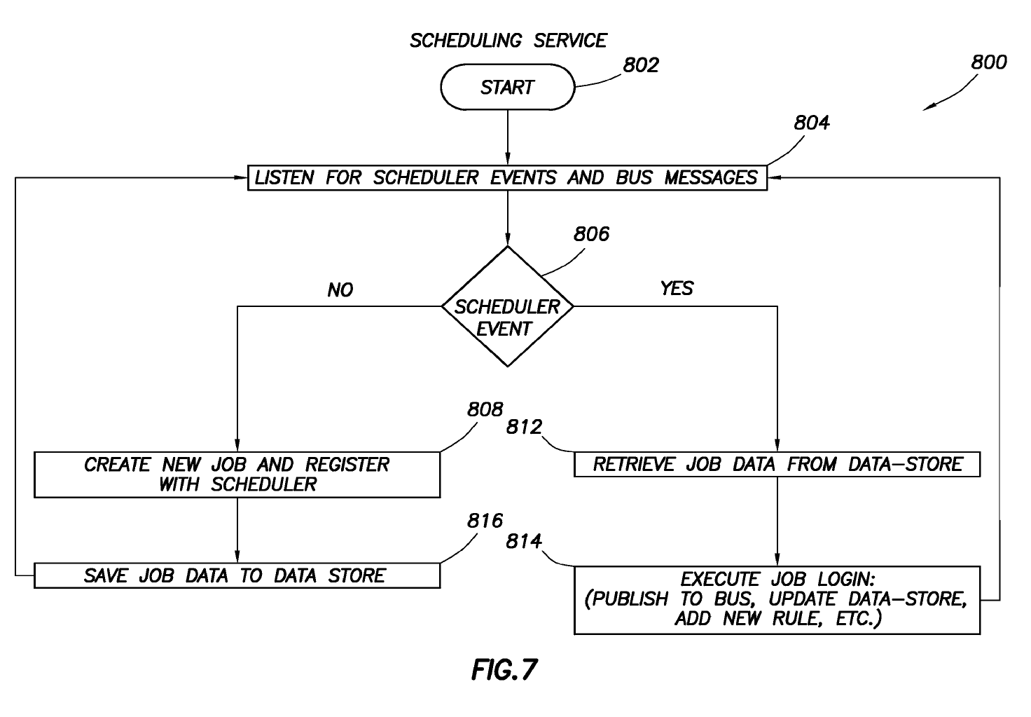

FIG. 7 is a schematic of an exemplary scheduling service 800 according to an aspect of the disclosure. The service starts at 802. The scheduling service listens for schedule events and bus messages (where a bus is in use) at 804. When a schedule event is detected at 806 and verified as an existing schedule event, job data is retrieved from the data store at 812, the job logic is executed at 814 (e.g., publish to bus, update data store, add new scheduled event or action, etc.). Where it is determined that the schedule event is not pre-existing, a new job is created and registered with the schedule service at 808 and saved to a data store at 810. Generally, the scheduling service provides for scheduling Load Shed signals. For example, a scheduled event can be to sell power to the grid upon reaching a selected market price, to reduce a load to a selected amount by or for a selected time, etc.

The scheduling service allows a user to remotely access the provider server, databases, etc., as needed, and to schedule actual control of facility equipment. The schedule service allows a condition or conditions to be set (i.e., time of day, date, if or only if conditions, etc.) upon which, when met, the service performs the scheduled actions. The scheduling service further allows identification and storage of actions to take with respect to identified equipment. For example, the user can schedule a testing run for a given time, on a given day of the month, wherein the provider services will automatically shut-down, reduce, increase power to, or run at maximum capacity the identified equipment. The monitoring services are still active and provide monitored data in real-time or on-demand. Further, the results of the action (i.e., measured load data, oil pressure or other equipment sensor data, etc.) can be processed by the provider service and further actions taken as needed (i.e., communication to appropriate parties, further control of the identified equipment, etc.). The scheduling service, in other words, can be used to automatically operate facility equipment according to pre-selected criteria. Such functionality is beneficial for example in hospital or health care facilities where generator tests must be performed routinely. A scheduling service event, for example, could trigger at a selected time and date to turn-on a first unit or transistor and run it for a selected time period; the process is repeated with a second, third, etc., units; and the units are turned off at selected times. Real-time monitoring of the units occurs as well as communication of monitored data. The provider service automatically compares the monitored data against a stored set of test results data. If the monitored unit data indicates that a unit “failed” the test, then the provider service automatically takes a remedial action such as notifying implicated parties, turning off the unit, taking the unit “off-line,” etc.

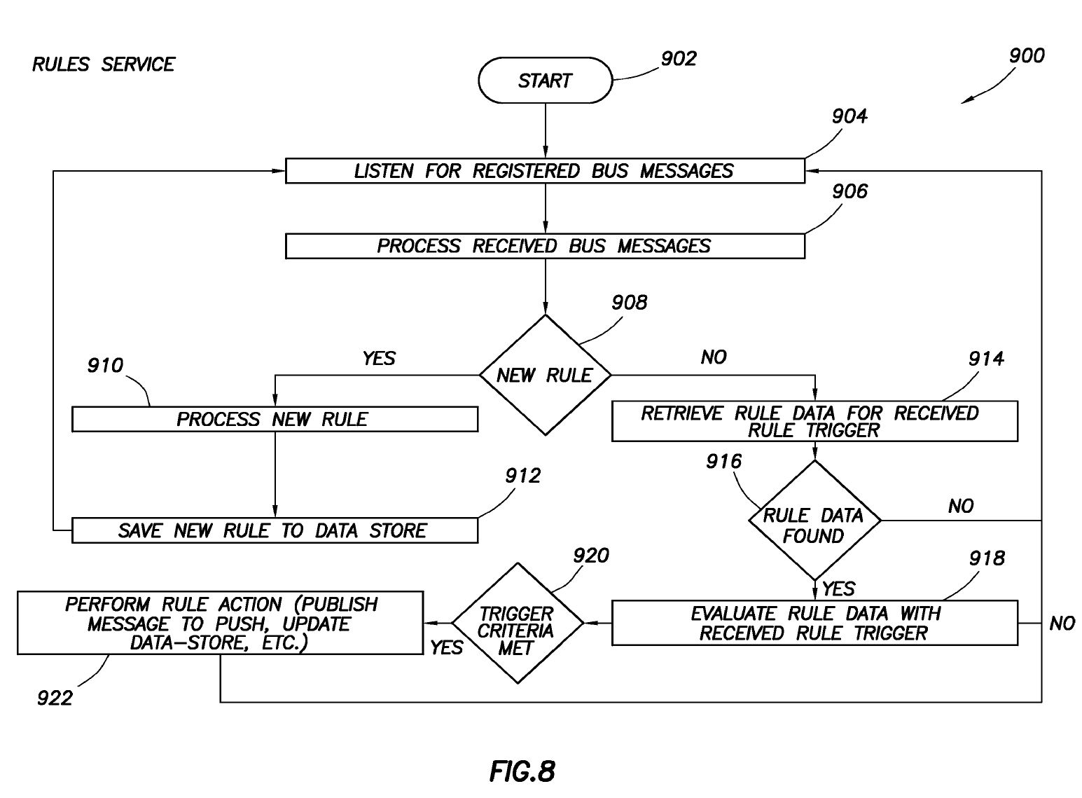

FIG. 8 is a schematic of an exemplary rules service 900 according to an aspect of the disclosure. The service starts at 902 and the rules service listens for registered bus messages at 904. When a message is received, it is processed at 906 to determine whether the message is a new rule at 908. A new rule is processed as such at 910 and saved to a data store at 912. Where the rule is not new, rule data is retrieved for the received rule trigger at 914. If rule data is not found, the process returns to 904. At 916, the rule data is located and evaluated with respect to the received rule trigger at 918. If trigger criteria is met, determined at 920, then the rule action is performed (e.g., publish message to push, update data-store, etc.) at 922. If trigger criteria is unmet, the process returns to 904. Generally, the rules service monitors equipment, meters, and Facility data, and provides if-then operation. For example, if a generator hits a selected temperature or oil pressure, the rules service responds by reducing or eliminating power generation by the generator.

The rules service, more simply described, receives and “reads” incoming data signals from monitored equipment, meters, gateways, etc. The incoming data is compared to stored instructions to determine if action is required. The stored data includes limits, triggers, conditions, sets of conditions, etc., for which a load-changing action is required. If the limit or condition is met, the rules service automatically takes action by sending instructions (i.e., signals, data, sets of software steps to perform, etc.) to the appropriate facility, gateway, etc. For example, the action automatically performed can be sending messages to appropriate gateways to turn off or down one or more pieces of electrical equipment at a facility. The gateway receives and interprets incoming messages and performs the action. Thus, the rules service receives and analyzes incoming data, and if indicated takes one or more actions, communicates with facility gateways and/or equipment, and actually alters and controls the operation of facility electric equipment, thereby changing the equipment and facility loads. The rules service further preferably allows access to the server by the consumer or user. That is, the consumer can remotely access the provider's server and/or connected databases to add, change, remove, etc., various “rules” governing when and how the service then automatically controls the facility equipment.

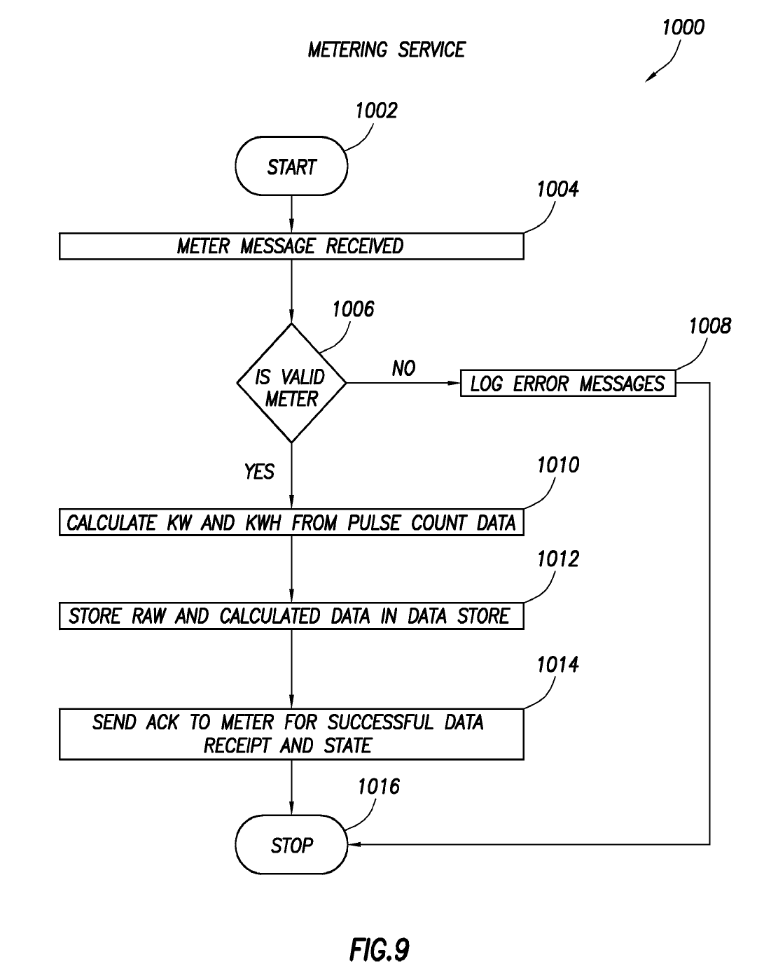

FIG. 9 is a schematic of an exemplary metering service 1000 according to an aspect of the disclosure. The service starts at 1002 and a meter message is received at 1004. A query for meter validity is posited at 1006. If invalid, an error message is logged at 1008 and the service stops at 1016. If valid, the service calculates relevant measurements (e.g., kW, kWh) from the pulse count data at 1010. The data is stored, both raw and calculated data, in a data store at 1012. At 1014, the service sends an acknowledgement message to the meter indicating a successful data receipt. The service stops at 1016. Generally, the metering service monitors and communicates meter data between the Facility meters and the Service Provider.

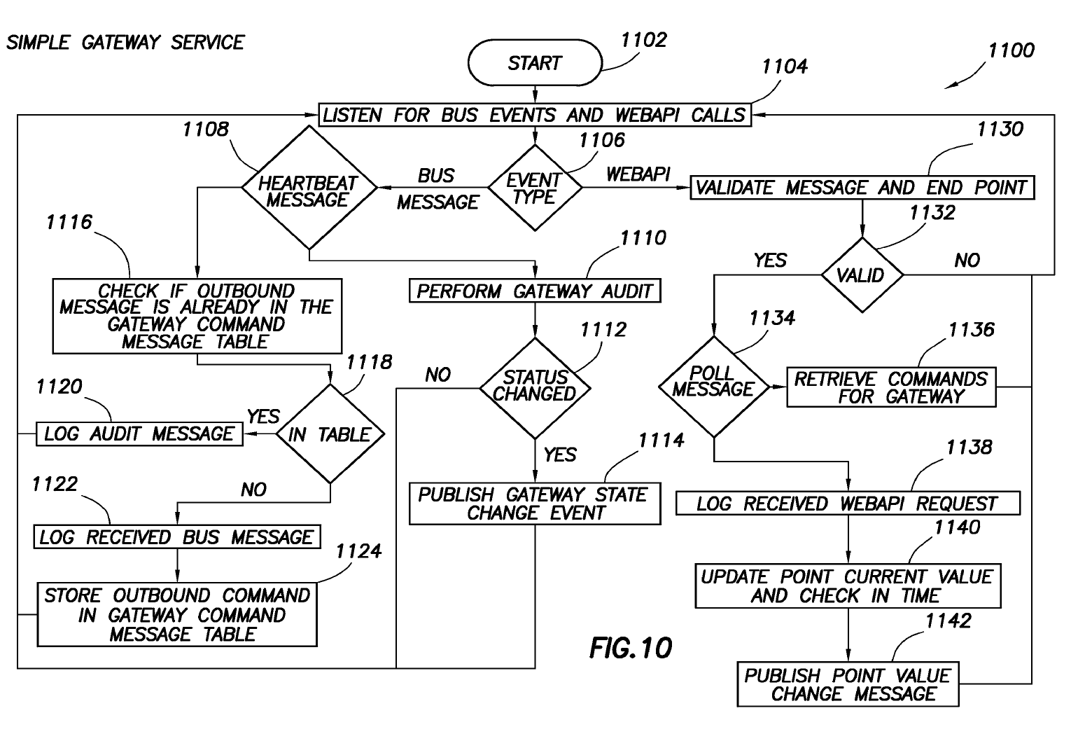

FIG. 10 is a schematic of an exemplary simple gateway service 1100 according to an aspect of the disclosure. The service starts at 1102 and listens for bus events and WebApi calls at 1104. An event type is determined at 1106. A bus message is queried as a heartbeat message at 1108. A Gateway audit is performed at 1110 if indicated to determine whether a status change has occurred at 1112. If so, a Gateway state change event is published at 1114. If not, the process returns to 1104. A heartbeat message results in a check to see if an outbound message is already in the Gateway command message table at 1116. If it is in the table at 1118, an audit message is logged at 1120. If not, a received bus message is logged at 1122 and is stored as an outbound command in the Gateway command message table at 1124. Alternately, where the event type is determined to be a WebApi call at 1130, the message and end point is validated at 1130. If determined to be valid at 1132, the message is polled at 1134 and commands for the Gateway are retrieved at 1136. If the polling is negative, commands for the Gateway are logged as received at 1136, the point current value and check-in time are updated at 1140, and the point value change m is published at 1142.

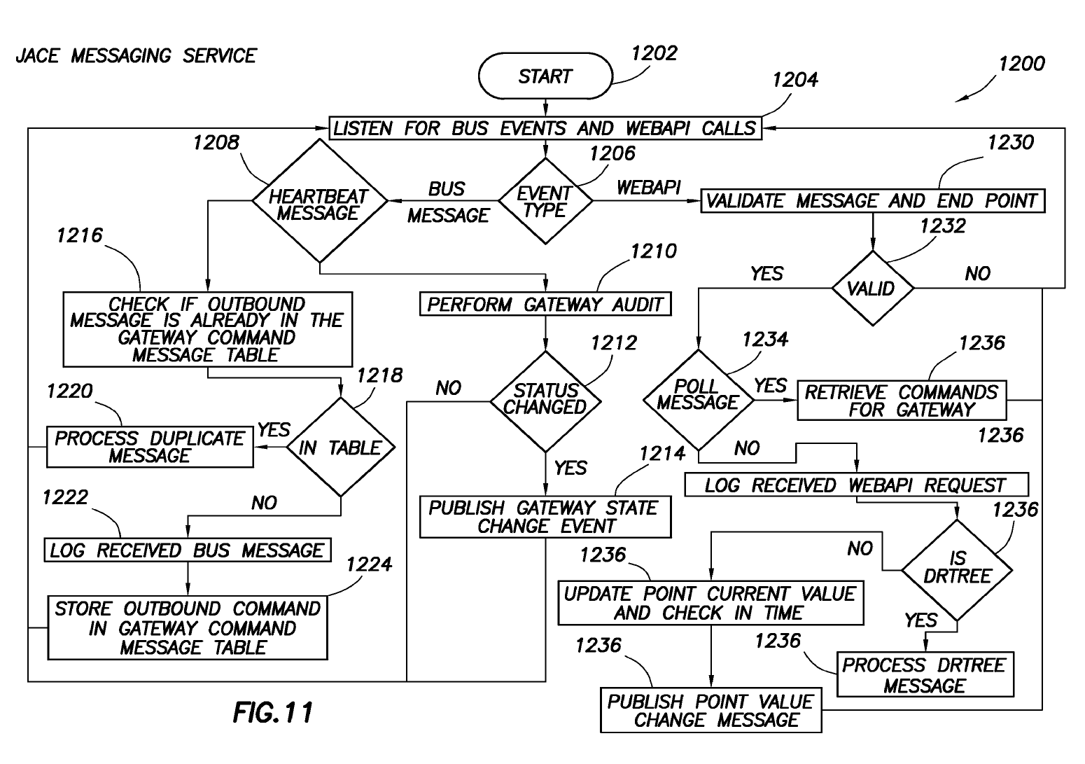

FIG. 11 is a schematic of an exemplary Controller messaging service 1200 according to an aspect of the disclosure. The service starts at 1202 and listen for bus events and WebApi calls at 1204. The event type is determined at 1206. A heartbeat message is routed at 1208. A Gateway audit is conducted at 1210 and a status change is queried at 1212. If the status has changed, a Gateway state change event is published at 1214. If not, the service returns to 1204. A heartbeat message results in a check to see if an outbound message is already in the Gateway command message table at 1216. If not found in the table at 1218, a received bus message is logged at 1220 and stored in the Gateway command message table at 1222. If the message is found in the table at 2118, a duplicate message is processed at 1224. A WebApi event message and end point are validated at 1230. If valid at 1232, the message is polled at 1234. If positive, commands for the Gateway are retrieved at 1236. If negative, a Received WebApi Request is logged at 1238. A DR tree check occurs at 1240, and a DR tree message is processed at 1242. Alternately, a point current value and check-in time are updated at 1244 and the point value change message is published at 1246.

The software-implemented services and processes described are exemplary. Those of skill in the art will recognize a variation of such services which can be used without departing from the spirit of the invention. Further, the services and processes described are dependent upon the hardware and software architecture selected (e.g., ESB, gateway types, etc.) and will necessarily vary depending on such choices.

Load Change Schemes

Load Shed Schemes are pre-planned, programmed, schemes for curtailment of electric power usage at a Facility. A scheme will indicate what facility and equipment is effected, how and to what degree load is shed for various equipment, potential exceptions and overrides, effective time frames, etc. For example, a scheme can determine that upon implementation of a Load Shed Scheme in response to a Load Shed Signal, that: Facility HVAC systems reduce their load immediately by a selected percentage; the several HVAC units implement load rotation; lighting in a lightly used wing be dimmed by a percentage; a generator be turned on or ramped up; etc.

A Load Shed Scheme indicates, for a Facility, a target load or target load reduction based on Load Shed Program requirements, type of Load Shed Signal received, or other selected conditions. The scheme also indicates targeted equipment for which electrical load is to be reduced (and not reduced), degree of reduction, manner of reduction (e.g., ramp down, percentage reduction, etc.), corresponding gateways and control points for implementing reductions, etc. A Scheme can be thought of as a blueprint for activities in response to an incoming Load Shed Signal.

Verification of targeted load or load curtailment in some embodiments occurs in real-time (or near real-time) based on active monitoring of Facility meters, meter data, equipment controllers and data, and system controllers and data. Depending on meter configuration, verification of load curtailment for a single piece of equipment, a group of equipment, or equipment slaved to a particular controller can be verified individually, if desired.

Load Shed Schemes can include directives to reduce Facility and equipment load in various ways. A load reduction measure can be implemented by: turning on or off certain equipment, changing the percentage of the equipment's maximum load being carried (i.e., reducing power from 80 to 40 percent), ramping up or down load (e.g., for equipment sensitive to sudden power loss), cycling power on and off or higher and lower to selected equipment, staggering load between pieces of equipment, etc. For example, small appliances can be turned off during a load shed event, lighting dimmed by reducing load by a selected percentage to selected lighting equipment, pump or machinery ramped slowly down to zero or other selected amount, HVAC systems cycled or staggered, etc., according to the implementation of a Scheme.

Load Resumption

Upon completion of the load shed event, the service can provide a simple reversal of load shed actions or cancellation of load shed commands, or it can implement a Load Restoration Scheme. Load Restoration can, for example, turn on equipment, ramp up power to selected equipment, increase percentage load on equipment to a pre-scheme or other designated amount, eliminate or reduce staggering and cycling of loads, etc.

Delayed Load Shed Action

Where a Load Shed Scheme includes load reduction to computers, servers, or other sensitive systems, the implementation can be delayed according to a programmed delay plan. For example, reduction can be delayed pending expiration of a time period, sending or confirmation of receipt of a notice to save data, or acceptance of the load reduction by a user. For example, upon implementation of the Scheme, the service automatically sends a signal or message to a computer or server to perform an immediate save of data, forced freeze-out of current network users, etc., to be performed by resident software.

Multiple Schemes

Multiple schemes can be created and stored, for example, on a database, for application in response to a Load Shed Signal or other event. The multiple schemes can be indicated for use based on selected criteria. For example, a first scheme can be implemented upon the presence (or absence) of certain conditions, while a second scheme is implemented in the absence (or presence) of those conditions. One of several schemes can be automatically implemented depending on a variety of factors. Such conditions and factors can include: time of day, day of week, season of the year, shift schedules, current or anticipated load usage, current or expected temperature, availability of alternate power supply (e.g., generator), etc. Further, for a given scheme, Facility electrical equipment and/or usage can be categorized or prioritized based on type, function, or criticality of the equipment with regard to Facility operations and load shed compliance.

For example, if a load shed signal is received for a load curtailment of 100 kW, a first Scheme is implemented to meet the targeted curtailment; if a signal is received for 500 kW, a second Scheme is implemented to meet the targeted curtailment; if a signal is received for a shed of 100 kW from a grid operator and a concurrent signal received from a market-driven program, a third scheme can be implemented to shed the total load desired or a first scheme can be activated and supplemented with a third scheme. This is useful, for example, where a multi-tiered Load Shed program can issue demand signals requiring lesser or greater load reductions based on grid conditions and needs, or where the Facility participates in multiple load shed programs (e.g., a grid operator program and a market-driven sell-back program).

Similarly, a first Scheme can provide for a first targeted reduction triggered by a first market price for electricity and a second Scheme for a targeted second reduction triggered by a second (different) market price. That is, a customer can elect to provide a small load curtailment at a selected price, and later increase their curtailment in response to a higher price. This allows balancing customer inconvenience due to curtailment with customer profit due to sale or sell-back of electricity at various price points. For example, a Facility may consider a hotter building interior temperature acceptable at a relatively higher market price but not at a lower price. A manufacturing Facility can elect curtailment at a market price point which results in profits greater than losses due to lost productivity. In fact, such Schemes can be implemented on a per product value, per production rate, or other manufacturing metric basis. That is, the Christmas season may bring a greater profit per produced item than during the spring season. The Facility can implement different curtailment schemes on that basis, such as by curtailing loads a lesser or greater amount, or selling-back load at lower or higher market prices, based on the season.

Further, differing Schemes can be applied at selected times (e.g., time of day, month, year, season, special events). A customer may elect to reduce or eliminate its participation in load curtailment or power sell-back during a critical time period. A department store can choose to forego reducing HVAC usage during a holiday weekend, for example. A stadium can forego curtailment during a scheduled event. A Facility such as a hotel, hospital, etc., can forego curtailment when at greater than a selected percentage of Facility capacity.

Iterative Schemes

Iterative Schemes can be designed and implemented to insure load shed compliance where an initial load shed scheme fails to meet a target load or load reduction. For example, a Scheme is implemented at a Facility. Real-time (or near real-time) measurements and corresponding data is received indicating that the load target is not met. In response to the insufficiency of the initial implementation as indicated by the real-time data, the Scheme is altered or a supplemental scheme is implemented further reducing current load. The process is repeated as needed until the target load shed is achieved.

For example, an initial scheme is implemented to reduce Facility load by a target amount of 100 kW, including ramping down power to an HVAC unit. For some reason the targeted reduction is not met (e.g., only an 80 kW reduction actually occurred) as indicated by Facility meters and controllers, the data sent to the remote service servers or databases, via the internet, for example. Target loads may not be met where there is an equipment or controller malfunction, a manual override or on-site action is performed, equipment is carrying an unexpectedly high load due to damage or poor maintenance, unknown or unaccounted for equipment is in use at the Facility, etc. The service implements a supplemental scheme to further curtail load. For example, a supplemental scheme might further ramp down the same HVAC unit, reduce load on other equipment, begin staggered usage of equipment, increase generator power, etc. The iterations (with successive iterations further reducing equipment load) continue until the load shed target is actually met.

Similarly, an iterative approach can be implemented to incrementally increase load where the load reduction target was not only met but exceeded. In such an embodiment, an initial load shed scheme is implemented in response to a load shed signal. The load program service communicates with facility controllers which, in turn, reduce the load of facility equipment. Continued monitoring and verification based on readings communicated from facility meters and controllers to the service server indicates a successful reduction of load and a reduction surplus. The service then implements a supplemental scheme or adjustment to increase equipment load to reduce the surplus. The subsequent load increase is preferably incremental to avoid falling below the load shed target. The procedure is repeated until an acceptable load is achieved. For example, where implementation of an initial load shed scheme results in a load shed of 120 kW, but the targeted load reduction is only 100 kW, a supplemental or subsequent scheme or adjustment can be made to increase load. For example, where load on an HVAC unit was reduced as part of the load shed scheme, the load to the HVAC unit can be incrementally increased until the actual load reduction is closer to the targeted load reduction.

Variable Schemes

Variable Schemes can be implemented as well. For example, an initial Scheme can be implemented with selected load shed actions to selected equipment to meet a target load reduction. Once the target load is reached, changes are implemented to the scheme, such as by changing load on one or more pieces of equipment (e.g., increasing load for an HVAC system while off-setting that load gain by reducing the load pulled by a water pump), or changing the load shed method in use on selected equipment (e.g., switching from a staggered use of HVAC systems to a simultaneous but reduced load pulled by the same HVAC systems).

Upon occurrence of a triggering event, such as a manual user selection, a pre-defined event or condition, measured parameters (e.g., building temperature), etc., the load shed Scheme is adjusted on-the-fly to alter the load shed actions to affected equipment while still maintaining the targeted Facility load. For example, a Scheme is implemented cutting Facility load to a targeted amount by staggering the multiple HVAC units (e.g., such that only one unit runs at a time) and by dimming lights by 30 percent in common areas. Upon sensing an unacceptable temperature rise, the Scheme is varied to allow multiple HVAC units to simultaneously run but cutting lighting to common areas by 60 percent, cutting outdoor lighting to zero, and cutting small appliance usage to zero. Alternately, a variable scheme can implement or increase supplemental power generation from a local generator upon a set of conditions.

Scheme Override

Scheme override services can be used to countermand or modify implementation of a Scheme. The override can be performed by the Service Provider or customer. The remote load management and control services, in such a case, can provide messages to an administrator or user indicating whether such an override results or is expected to result in a load rise above the curtailment target. Similarly, the service can suggest concurrent or subsequent load reductions to other equipment to cancel out the loss, or expected loss, of load reduction due to the override. Alternately, the service can automatically curtail power to other equipment in response to the override.

Load Shed Prediction

Further, Schemes can include actions to be performed in response to expected, potential, or forecast demand signals. Based on historical data, the load management service can “forecast” that a Load Shed Signal is expected to occur within a few hours. For example, the service can take current and forecast weather data from a third-party source, current time of day, current and expected grid conditions, and historical grid status under similar conditions, and conclude a Load Shed Signal is likely to occur. In response, the service can implement a Scheme in anticipation of the expected signal to assist in meeting the later-signaled demand when it occurs.

For example, upon determination that a signal is forthcoming, a Scheme can be implemented which increases power to selected equipment temporarily in advance of the anticipated Load Shed signal. The temporary load change can be stopped upon receipt of the load shed signal or when a pre-selected condition is met. For example, HVAC systems can be turned up to pre-cool a Facility prior to an expected load curtailment which will implicate the HVAC systems. If a load shed signal is then received, the HVAC load is reduced in accordance with the load shed scheme. Alternately, if the Facility temperature reaches a selected, pre-cooled temperature, then the HVAC system load can revert to normal. As another example, a water pump can be activated, or pump rate increased, to supply an elevated tank in anticipation of a load curtailment which will effect pump load. In another example, a “data save” event can be implemented on selected servers and computers in advance of expected load reduction.

Peak Demand, Peak Use

In another example, based on historical data and other indicators, the service can forecast the occurrence of a Facility peak demand or peak usage. Where electric prices or tariffs are dependent in part on a Facility's measured peak usage over a time period, a cost savings can be achieved by reducing the anticipated peak demand. For example, based on historical and current data, the service can predict a potential peak demand and implement a Scheme to reduce Facility demand to a target load by, for example, reducing load pulled by selected equipment for a selected period. Anticipation of a peak demand event can be based on past Facility peak demand, past equipment usage patterns, equipment maximum loads, current Facility load, current equipment load, current and predicted weather conditions, historical grid conditions, etc., and correlations and relationships therebetween.

Storage of the Schemes can be on the Service Provider network, customer network, or third-party network. Software implementation of the schemes can occur at the Service Provider network, the customer network, a third-party network, or a combination thereof.

A Scheme for a Facility includes a list of gateways and electrical equipment implicated in the scheme, a list of load-altering actions to be implemented with respect to the gateways and equipment, and other related data, A Scheme provides, for a given Facility target load reduction, target load reductions for equipment (per piece or by group), such as lights, appliances, computer system, control systems, heavy machinery. HVAC, etc. The command signals to implement a Scheme, or implement load reductions according to the Scheme, are transmitted from or at the control of the Service Provider network, The commands can be sent via the internet and through the Service Provider and Facility gateways as discussed elsewhere herein.

Computer Implemented Method Definitions

Computer/Computerized System

The system, methods, services, processes, and other embodiments according to the present disclosure include computerized systems requiring the performance of one or more methods or steps performed on or in association with one or more computer. (A computer or a computerized system is not to be considered or treated as a means-plus-function element as used herein.)

A computer is a programmable machine having two principal characteristics, namely, it responds to a set of instructions in a well-defined manner and can execute a pre-recorded list of instructions (e.g., a program). A computer according to the present disclosure is a device with a processor and a memory. For purposes of this disclosure, a computer is defined to include servers, personal computers, (i.e., desktop computers, laptop computers, netbooks, tablets), “smart” mobile communications device (e.g., smart phones), and devices providing functionality through internal components or connection to an external component (e.g., computer, server, or global communications network (such as the internet)) to take direction from or engage in processes which are then delivered to other system components.

Those of skill in the art recognize that other devices, alone or in conjunction with an architecture associated with a system, can provide a computerized environment for carrying out the methods disclosed herein. The method and process aspects of the disclosure are computer-implemented and, more particularly, at least one step is carried out using a computer.

General-purpose computers include hardware components. A memory or memory device enables a computer to store data and programs. Common storage devices include disk drives, tape drives, thumb drives, and others known in the art. An input device can be a keyboard, mouse, hand-held controller, remote controller, a touchscreen, and other input devices known in the art. The input device is the conduit through which data and instructions enter a computer. An output device is a display screen, printer, or other device letting the user sense what the computer has accomplished, is accomplishing, or is expected to accomplish. A central processing unit (CPU) is the “brains” of the computer and executes instructions and performs calculations. For example, typical components of a CPU are an arithmetic logic unit (ALU), which performs arithmetic and logical operations and a control unit (CU) which extracts instructions from memory, decodes and executes them, calling on the ALU when necessary. The CPU can be a micro-processor, processor, one or more printed circuit boards (PCBs). In addition to these components, others make it possible for computer components to work together or in conjunction with external devices and systems, for example, a bus to transmit data within the computer, ports for connectivity to external devices or data transmission systems (such as the internet), wireless transmitters, read and read-write devices, etc., such as are known in the art.

Server

A server is a computer or device on a network that manages network resources. There are many different types of servers, including remote, live and network access servers, data servers, member servers, staging servers, etc. A server can be hardware and/or software that manages access to a centralized resource or service in a network. For purposes of this disclosure, the term “server” also includes “virtual servers” which can be hosted on actual servers.

Network

A computerized or data network is a communications network allowing computers to exchange data, with networked devices passing data to each other on data connections. Network devices that originate, route, and terminate data are called nodes. The connections (links) between nodes are established using wire or wireless media. Nodes can include hosts, such as PCs, phones, servers, and networking hardware. Devices are networked together when one device is able to exchange information with the other device whether or not they have a direct connection to each other. Computer networks support applications such as access to the World Wide Web (WWW) or internet, shared use of application and storage servers, printers, and use of email and instant messaging applications. Computer networks can differ in the physical media used to transmit signals, protocols to organize network traffic, size, topology, and organizational intent. The network can include routers, databases, wired or wireless connectivity, user interfaces, override controls, etc. The network provides connectivity to multiple pieces of equipment pulling or capable of pulling an electric load. A network provides connectivity to the internet, and through the internet (or directly) to a provider network, networks, server, or servers. A provider network can include servers (actual or virtual), and other hardware and software, as well as other network devices. The remote provider network stores and manages content, such as software programs for controlling one or more remote private networks. The control content made available by the provider allows monitoring, control, messaging, use-management software or data, interface or protocol software, software or data for synchronization, and other services to, from, or for one or more independent networks.

Gateway

A Gateway is a network node that acts as an entrance to another network. The gateway can be an ISP (internet service provider) that connects a user to the internet, for example. In enterprises, the gateway node often also incorporates services such as proxy server, firewall, encryption, compression, de-duplication, optimization, version control, and data protection. The gateway is also associated with or includes a router, which uses headers and forwarding tables to determine where data packets are sent, and a switch, which provides the actual path for the packet in and out of the gateway. A gateway can be software, hardware or a combination thereof. A gateway for connecting a user with a public or private network is typically located at the user's Facility and serves as a “bridge” between local applications and remote, internet-based, or cloud-based storage or applications. A gateway provides protocol translation and connectivity to allow incompatible technologies to communicate transparently. The gateway can make retrieved, received, or communicated data appear to the local user as an NAS (network attached storage) filer, a block storage array, a backup target, a server, or an extension of the application itself. Local storage can be used as a cache for improved performance.

Database

The disclosure includes one or more databases (memory devices, memories, hard-drives, etc.) for storing information relating to aspects of the disclosure. The information stored on a database can, for example, be related to a private subscriber, a content provider, a host, a security provider, etc. One of ordinary skill in the art appreciates that “a database” can be a plurality of databases, each of which can be linked to one another, accessible by a user via a user interface, stored on a computer readable medium or a memory of a computer (e.g., PC, server, etc.), and accessed by users via global communications networks (e.g., the internet) which may be linked using satellites, wired technologies, or wireless technologies.

Exemplary Computerized System

In exemplary embodiments of the disclosure, a computerized system includes a computer, a memory or database, a computer program or application, a network, a user interface, and communications components to operably connect these (e.g., wires, wireless transmitters and receivers, etc.). The computer program is stored in one or more memory or database and executed by one or more computer. A user interface provides a user, whether the service provider or a consumer, with a visual display of program data and, in conjunction with one or more input device, a mechanism for communicating with the program, memory, etc., of the system. Communication between the service provider and consumer is via the internet or cellular network, for example. Parts or all of the various programs, databases, data, and connectivity elements can reside in or be split among separate computers and memory storages. One or more computers execute the one or more computer programs, applications, or services, and communicate via network to one or more databases or other computers.

The Cloud/Cloud Computing/SaaS

In computer networking, “cloud computing” is used to describe a variety of concepts involving a large number of computers connected through a network (e.g., the Internet). The phrase is often used in reference to network-based services, which appear to be provided by real server hardware, but which are in fact served by virtual hardware, simulated by software running on one or more machines. Virtual servers do not physically exist and can therefore be moved around, scaled up or down, etc., without affecting the user.

In common usage, “the cloud” is essentially a metaphor for the internet. “In the cloud” also refers to software, platforms, and infrastructure sold “as a service” (i.e., remotely through the internet). The supplier has actual servers which host products and services from a remote location, so that individual users do not require servers of their own. End-users can simply log-on to the network, often without installing anything, and access software, platforms, etc. Models of cloud computing service are known as software as a service, platform as a service, and infrastructure as a service. Cloud services may be offered in a public, private, or hybrid networks. Google, Amazon, Oracle Cloud, and Microsoft Azure are well-known cloud vendors.

Software as a service (SaaS) is a software delivery model in which software and associated data are centrally hosted on the Cloud. Under SaaS, a software provider licenses a software application to clients for use as a service on demand, e.g., through a subscription, time subscription, etc. SaaS allows the provider to develop, host, and operate a software application for use by clients who just need a computer with internet access to download and run the software application and/or to access a host to run the software application. The software application can be licensed to a single user or a group of users, and each user may have many clients and/or client sessions.

Typically, SaaS systems are hosted in datacenters whose infrastructure provides a set of resources and application services to a set of multiple tenants. A “tenant” can refer to a distinct user or group of users having a service contract with the provider to support a specific service. Most SaaS solutions use a multi-tenant architecture where a single version of the application, having a single configuration (i.e., hardware, operating system, and network) is used by all tenants (customers). The application can be scaled by installation on several machines. Other solutions can be used, such as virtualization, to manage large numbers of customers. SaaS supports customization in that the application provides defined configuration options allowing each customer to alter their configuration parameters and options to choose functionality and “look and feel.”

SaaS services are supplied by independent software vendors (ISVs) or Application Service Providers (ASPs). SaaS is a common delivery model for business applications (e.g., office and messaging, management, and development software, and for accounting, collaboration, management information systems (MIS), invoicing, and content management.

SaaS is an advantage to end-users in that they do not need to provide hardware and software to store, back-up, manage, update, and execute the provided software. Since SaaS applications cannot access the user's private systems (databases), they often offer integration protocols and application programming interfaces (API) such as http (hypertext transfer protocol), REST (representational state transfer), SOAP (simple object access protocol), and JSON (JavaScript Object Notation).

Method Claim Support

The disclosure is provided in support of any methods claimed or which may be later claimed. Specifically, support is provided to meet the technical, procedural, or substantive requirements of certain examining offices. It is expressly understood that the portions or actions of the methods can be performed in any order, unless specified or otherwise necessary, that each portion of the method can be repeated, performed in orders other than those presented, that additional actions can be performed between the enumerated actions, and that, unless stated otherwise, actions can be omitted or moved. Those of skill in the art will recognize the various possible combinations and permutations of actions performable in the methods disclosed herein without an explicit listing of every possible such combination or permutation. It is explicitly disclosed and understood that the actions disclosed can be performed in any order (xyz, xzy, yxz, yzx, etc.) without the wasteful and tedious inclusion of writing out every such order. Further, it is understood that listed actions can be repeated, in various order, in disclosed embodiments (e.g., xxyz, xyxyz, etc.), omitted in some embodiments (e.g., xz, yz, etc.), and can have unlisted actions between listed actions (e.g., xyza, xayz, axyz, etc., where “a” indicates an unlisted element).

The disclosure specifically teaches the following methods, with the steps in the listed order and in varying orders. Numbering is used to indicate that the steps, elements, limitations, etc., of numbers greater than one can be added to those listed at number one. The additional steps or elements can be inserted at various (any) points in the methods described at number one (unless a numbered description specifically indicated otherwise). An exemplary method is described generally as: 1. A method of remotely controlling a facility electric load using a computer to execute a non-transitory program stored in a memory, the facility having a plurality of electrical equipment each pulling an electrical equipment load, the aggregate of the electrical equipment loads defining the facility electric load, the method comprising: a) remotely monitoring the facility load via the internet using the computer and non-transitory computer program stored in the memory; b) receiving a load change signal from a remote source via the internet; c) in response to the received load change signal, using the computer program, automatically correlating the received load change signal with an implicated facility utilizing facility data stored in the memory; d) in response to correlating the load change signal with a facility, and using the computer program, automatically and remotely communicating, via the internet, with one or more gateways at the facility, each gateway controlling operation of one or more of the plurality of electrical equipment; e) automatically controlling, via the one or more gateways, operation of at least one of the plurality of electrical equipment at the facility and changing the facility electric load and at least one of the electrical equipment loads; f) automatically verifying the changed electrical equipment or facility loads in real time, via the internet.

The following additional steps, elements, limitations, etc., can be optionally added to those of the exemplary method numbered one; these additionally described methods can be repeated, inserted at various points in the exemplary method numbered one, can replace steps in exemplary method number one, etc. Further, each of the below-described steps can be added together, mixed in order, etc., unless indicated otherwise or contrary to principles known to those of skill in the art. 2. The exemplary method indicated above, for ease of reference, as number 1, further comprising: reducing facility load by at least a targeted load reduction using targeted load reduction data stored in the memory. 3. The exemplary method of number 2, further comprising: in response to verifying the changed electrical equipment or facility loads, automatically further reducing at least one of the electrical equipment loads by further controlling at least one of the plurality of electrical equipment at the facility. 4. The exemplary method of number 1, wherein e) further comprises: reducing the facility load according to a pre-programmed load change scheme stored in the memory. 5. The exemplary method of number 4, further comprising: h) automatically implementing the load change scheme in response to selected, automatically remotely-monitored, facility or equipment data. 6. The exemplary method of number 1, wherein f) further comprises altering the current load of selected pieces of electrical equipment by any of the following actions: altering the electrical load of a piece of equipment by a percentage, ramping-down the electrical load of a piece of equipment, ramping-up the electrical load of a piece of equipment, turning on or off a piece of equipment, cycling a piece of equipment on and off, and cycling the load of a piece of equipment. 7. The exemplary method of number 1, further comprising increasing alternative, off-grid power generation at the facility and inputting the generating electrical power into the electrical equipment at the facility or into the grid. 8. The exemplary method of number 1, further comprising: predicting the occurrence of a load change signal based on historical load data, current load data, and non-load data; and, in response to the prediction, and prior to occurrence of the load change signal, altering the load on at least one piece of the electrical equipment. 9. The exemplary method of number 8, wherein altering the load of at least one piece of electrical equipment includes increasing the electrical load of a piece of electrical equipment comprising a cooling unit, thereby pre-cooling the facility. 10. The exemplary method of number 1, wherein a) further comprises monitoring a sub-meter, a smart meter, or an IDR meter at the facility. 11. The exemplary method of number 10, wherein d) further comprises communicating with a generator gateway, an ATS gateway, a smart meter gateway, an IDR meter gateway, or a JACE (trade name) gateway located at the facility. 12. The exemplary method of number 11, further comprising sending a data acquisition request to or receiving pushed data from, via the internet, a plurality of the gateways, the meters, or the pieces of electrical equipment at the facility. 13. The exemplary method of number 1, further comprising automatically and remotely communicating, via the internet, with one or more third-party source, wherein the third-party source provides data regarding current, historical, or anticipated weather conditions, grid conditions, or electrical power price conditions. 14. The exemplary method of number 1, further comprising automatically and remotely communicating with a third-party source, via the internet, real time meter data, gateway data, load data, or load change data. 15. The exemplary method of number 1, wherein the load change signal comprises one or more market prices, one or more demand response program signals, or an expected peak use event. 16. The exemplary method of number 1, further comprising predicting, using a predictive software program stored in the memory, and using historical load data, current load data, or correlative data, a predicted peak load. 17. The exemplary method of number 1, wherein the memory comprises one or more remote memories accessible via the internet.

The disclosure specifically teaches the following systems and methods thereof, with the steps in the listed order and in varying orders. Numbering is used to indicate that the steps, elements, limitations, etc., of numbers greater than one can be added to those listed at number eighteen. The additional steps or elements can be inserted at various (any) points in the methods described at number eighteen (unless specifically indicated otherwise). An exemplary method is described generally as: 18. A computerized system for remotely controlling a facility electric load, the facility having a plurality of electrical equipment each having an electrical equipment load, the aggregate of the electrical equipment loads defining the facility electric load, the system comprising: a computer; a memory; a user interface; and a non-transitory computer program stored in the memory and executable by the computer to: a) remotely monitor the facility load via the internet; b) receive a load change signal from a remote source; c) communicate with a gateway at the facility, the gateway controlling operation of at least one piece of electrical equipment; e) controlling, via the gateway, operation of at least one piece of electrical equipment; f) changing the electrical equipment load of at least one piece of the electrical equipment and the facility load; g) verifying the change in equipment or facility load in real time.

The following additional steps, elements, limitations, etc., can be optionally added to those of the exemplary system numbered eighteen above; these additionally described methods can be repeated, inserted at various points in the exemplary method numbered eighteen, can replace steps in exemplary method number eighteen, etc. Further, each of the below-described steps can be added together, mixed in order, etc., unless indicated otherwise or contrary to principles known to those of skill in the art. 19. The system of number 18, the program further executable to compare real time equipment or facility load to a targeted load, and in response to the comparison, further change at least one electrical equipment load, and verify the further change in real time. 20. The system of number 18, the program further executable to iteratively: control electrical equipment to change electrical equipment load and facility load, verify the change in electrical equipment load or facility load, compare the changed electrical equipment load or facility load to a target load, and in response to the comparison, determine additional electrical equipment controls to implement, communicate the additional controls to the gateways. 21. The exemplary method of number 18, the program further executable to retrieve from memory and execute a pre-programmed load change scheme. 22. The exemplary method of number 21, the program further executable to select and execute a load change scheme in response to monitored facility or equipment data. 23. The exemplary method of number 21, the program further executable to select and execute a load change scheme in response to monitored market data. 24. The exemplary method of number 21, the program further executable to analyze historical and current grid conditions, historical and current facility loads, correlative load data, weather data, or any combination thereof; and predict, using a predictive software program, occurrence of a load change signal, a peak usage event, or a market condition; and, in response to the prediction, select and execute a load change scheme.

The disclosure specifically teaches the following systems and methods thereof, with the steps in the listed order and in varying orders. Numbering is used to indicate that the steps, elements, limitations, etc., of numbers greater than one can be added to those listed at number eighteen. The additional steps or elements can be inserted at various (any) points in the methods described at number eighteen (unless specifically indicated otherwise). An exemplary method is described generally as: 25. A computerized service provider system for remotely managing a facility electric load, the system comprising: a server connected to the internet via one or more routers; a non-transitory computer program stored in a memory accessible by the server; a graphic user interface connected to the server to display data; facility data stored in a database accessible by the service provider server; a non-transitory computer program accessible by the server and operable to: remotely monitor the facility load; receive a load change signal from a remote source via the internet; communicate with facility gateways to control operation of facility electrical equipment; change an electrical equipment load and the facility load; and verify the change in real time.

Conclusion

The words or terms used herein have their plain, ordinary meaning in the field of this disclosure, except to the extent explicitly and clearly defined in this disclosure or unless the specific context otherwise requires a different meaning.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed.

As used herein, the words “consisting essentially of,” and all grammatical variations thereof, are intended to limit the scope of a claim to the specified materials or steps and those that do not materially affect the basic and novel characteristic(s) of the claimed disclosure.

The indefinite articles “a” or “an” mean one or more than one of the component, part, or step that the article introduces. The terms “and,” “or,” and “and/or” shall be read in the least restrictive sense possible. Each numerical value should be read once as modified by the term “about” (unless already expressly so modified), and then read again as not so modified, unless otherwise indicated in context.

While the foregoing written description of the disclosure enables one of ordinary skill to make and use the embodiments discussed, those of ordinary skill will understand and appreciate the existence of variations, combinations, and equivalents of the specific embodiments, methods, and examples herein. The invention should therefore not be limited by the above described embodiments, methods, and examples. While this disclosure has been described with reference to illustrative embodiments, this description is not intended to be construed in a limiting sense. Various modifications and combinations of the illustrative embodiments as well as other embodiments of the invention will be apparent to persons skilled in the art upon reference to the description. It is, therefore, intended that the appended claims encompass any such modifications or embodiments.

It will be appreciated that one or more of the above embodiments may be combined with one or more of the other embodiments, unless explicitly stated otherwise. The disclosure illustratively disclosed herein suitably may be practiced in the absence of any element or step that is not specifically disclosed or claimed. Furthermore, no limitations are intended to the details of construction, composition, design, or steps herein shown, other than as described in the claims.

The following are incorporated herein by reference in their entirety for all purposes, including claim support, and without limitation: U.S. Pat. No. 8,457,803 to Willig and all references listed on the face thereof; No. 8,726,059 to Acosta-Cazaubon and all references listed on the face thereof; No. 8,738,943 to Amadeu and all references listed on the face thereof; and U.S. Patent App. Pub. US 2010/0063641 to Scholten and any references provided therein.

We claim:

1. A method of remotely controlling a facility electric load using a computer to execute a non-transitory program stored in a memory, the facility having a plurality of electrical equipment each pulling an electrical equipment load, the aggregate of the electrical equipment loads defining the facility electric load, the method comprising:
a) remotely monitoring the facility load via the internet using the computer and non-transitory computer program stored in the memory;
b) receiving a load change signal from a remote source via the internet;
c) in response to the received load change signal, using the computer program, automatically correlating the received load change signal with an implicated facility utilizing facility data stored in the memory;
d) in response to correlating the load change signal with a facility, and using the computer program, automatically and remotely communicating, via the internet, with one or more gateways at the facility, each gateway controlling operation of one or more of the plurality of electrical equipment;
e) automatically controlling, via the one or more gateways, operation of at least one of the plurality of electrical equipment at the facility and changing the facility electric load and at least one of the electrical equipment loads;
f) automatically verifying the changed electrical equipment or facility loads in real time, via the internet.

2. The method of claim 1, further comprising: reducing facility load by at least a targeted load reduction using targeted load reduction data stored in the memory.

3. The method of claim 2, further comprising: in response to verifying the changed electrical equipment or facility loads, automatically further reducing at least one of the electrical equipment loads by further controlling at least one of the plurality of electrical equipment at the facility.

4. The method of claim 1, wherein e) further comprises: reducing the facility load according to a pre-programmed load change scheme stored in the memory.

5. The method of claim 4, further comprising: h) automatically implementing the load change scheme in response to selected, automatically remotely-monitored, facility or equipment data.

6. The method of claim 1, wherein f) further comprises altering the current load of selected pieces of electrical equipment by any of the following actions: altering the electrical load of a piece of equipment by a percentage, ramping-down the electrical load of a piece of equipment, ramping-up the electrical load of a piece of equipment, turning on or off a piece of equipment, cycling a piece of equipment on and off, and cycling the load of a piece of equipment.

7. The method of claim 1, further comprising increasing alternative, off-grid power generation at the facility and inputting the generating electrical power into the electrical equipment at the facility or into the grid.

8. The method of claim 1, further comprising: predicting the occurrence of a load change signal based on historical load data, current load data, and non-load data; and, in response to the prediction, and prior to occurrence of the load change signal, altering the load on at least one piece of the electrical equipment.

9. The method of claim 8, wherein altering the load of at least one piece of electrical equipment includes increasing the electrical load of a piece of electrical equipment comprising a cooling unit, thereby pre-cooling the facility.

10. The method of claim 1, wherein a) further comprises monitoring a sub-meter, a smart meter, or an IDR meter at the facility.

11. The method of claim 10, wherein d) further comprises communicating with a generator gateway, an ATS gateway, a smart meter gateway, an IDR meter gateway, or a JACE (trade name) gateway located at the facility.

12. The method of claim 11, further comprising sending a data acquisition request to or receiving pushed data from, via the internet, a plurality of the gateways, the meters, or the pieces of electrical equipment at the facility.

13. The method of claim 1, further comprising automatically and remotely communicating, via the internet, with one or more third-party source, wherein the third-party source provides data regarding current, historical, or anticipated weather conditions, grid conditions, or electrical power price conditions.

14. The method of claim 1, further comprising automatically and remotely communicating with a third-party source, via the internet, real time meter data, gateway data, load data, or load change data.

15. The method of claim 1, wherein the load change signal comprises one or more market prices, one or more demand response program signals, or an expected peak use event.

16. The method of claim 1, further comprising predicting, using a predictive software program stored in the memory, and using historical load data, current load data, or correlative data, a predicted peak load.

17. The method of claim 1, wherein the memory comprises one or more remote memories accessible via the internet.

18. A computerized system for remotely controlling a facility electric load, the facility having a plurality of electrical equipment each having an electrical equipment load, the aggregate of the electrical equipment loads defining the facility electric load, the system comprising:
a computer;
a memory;
a user interface; and
a non-transitory computer program stored in the memory and executable by the computer to:
a) remotely monitor the facility load via the internet;
b) receive a load change signal from a remote source;
c) communicate with a gateway at the facility, the gateway controlling operation of at least one piece of electrical equipment;
e) controlling, via the gateway, operation of at least one piece of electrical equipment;
f) changing the electrical equipment load of at least one piece of the electrical equipment and the facility load;
g) verifying the change in equipment or facility load in real time.

19. The system of claim 18, the program further executable to compare real time equipment or facility load to a targeted load, and in response to the comparison, further change at least one electrical equipment load, and verify the further change in real time.

20. The system of claim 18, the program further executable to iteratively: control electrical equipment to change electrical equipment load and facility load, verify the change in electrical equipment load or facility load, compare the changed electrical equipment load or facility load to a target load, and in response to the comparison, determine additional electrical equipment controls to implement, communicate the additional controls to the gateways.

21. The method of claim 18, the program further executable to retrieve from memory and execute a pre-programmed load change scheme.

22. The method of claim 21, the program further executable to select and execute a load change scheme in response to monitored facility or equipment data.

23. The method of claim 21, the program further executable to select and execute a load change scheme in response to monitored market data.

24. The method of claim 21, the program further executable to analyze historical and current grid conditions, historical and current facility loads, correlative load data, weather data, or any combination thereof; and predict, using a predictive software program, occurrence of a load change signal, a peak usage event, or a market condition; and, in response to the prediction, select and execute a load change scheme.

25. A computerized service provider system for remotely managing a facility electric load, the system comprising:
a server connected to the internet via one or more routers;
a non-transitory computer program stored in a memory accessible by the server;
a graphic user interface connected to the server to display data;
facility data stored in a database accessible by the service provider server;
a non-transitory computer program accessible by the server and operable to:
remotely monitor the facility load;
receive a load change signal from a remote source via the internet;
communicate with facility gateways to control operation of facility electrical equipment;
change an electrical equipment load and the facility load;
verify the change in real time.
